(19) United States
(12) Patent Application Publication
(10) Pub. No.: US 2007/0057214 A1
(43) Pub. Date: Mar. 15, 2007

(54) Valve for essentially gastight closing a flow path

(75) Inventor: Gebhard Lutz, Schlins (AT)

Correspondence Address: OLIFF & BERRIDGE, PLC, P.O. BOX 19928, ALEXANDRIA, VA, 22320, US

(73) Assignee: VAT HOLDING AG, Haag (CH)

(21) Appl. No.: 11/221,833

(22) Filed: Sep. 9, 2005

(51) Int. Cl. F16K 31/122

(52) U.S. Cl. 251/63.5

(57) ABSTRACT

Maintenance-friendly, compact valve having a simple design for essentially gastight closing of a flow path (F) between two ports (3, 5) arranged at an angle. A valve part which is arranged in a valve housing (2) so as to be displaceable along an axis (10) and whose closing surface (13) can be brought into contact with a valve seat (7) of the first port (3) for closing the flow path (F) and can be brought out of contact for opening the flow path (F) is in the form of a cylindrical piston (9) having an end face forming the closing surface (13) and a piston outer surface (16). The valve housing (2) has a cylindrical passage (17) which extends opposite the valve seat (7) along the axis (10) and through which the piston (9) is passed and can be displaced and inside which a sealing or guide element (15, 18; 19) is arranged. The piston (9) and the passage (17) are dimensioned so that the piston outer surface (16) is closely enclosed along the adjustment distance (a) by the sealing or guide element (15, 18; 19) of the passage (17). It is thus possible for essentially only a single adjustable component of the valve, namely the easily cleanable piston (9) consisting in particular of a single material, to be guided in the flow space (R) so that the maintenance of the valve (1) is substantially simplified and few different materials bound the flow space (R). In a further development, the drive mechanism (14) of the piston (9) is formed at least partly by an outer piston space (A) between a piston step (21) and the passage (17), so that the piston (9) forms a component of the drive mechanism (14), permitting a compact design of the valve (1).

### FIELD OF THE INVENTION

The present invention relates to a valve for essentially gastight closing of a flow path between two ports arranged at an angle. In particular, the invention relates to a valve comprising a valve part whose closing surface can be brought into contact with a valve seat of a first port for closing the flow path and can be brought out of contact for opening the flow path. Such valves are used especially in vacuum technology and are referred to in particular as a vacuum angle valve.

### DESCRIPTION OF THE PRIOR ART

Valves of the type mentioned at the outset are known in various embodiments from the prior art. Vacuum valves are used in particular in the area of IC and semiconductor production, which has to take place in a protected atmosphere as far as possible without the presence of contaminating particles.

A valve disclosed in the prior art and described, for example, in U.S. Pat. No. 6,772,989 has a valve body comprising two ports arranged in a direction perpendicular to one another, a valve seat arranged in the flow space in a flow path connecting the two ports, and an opening opposite the valve seat. Arranged in a valve cover closing the opening is a piston of a pneumatic cylinder system which drives, via a valve rod, a valve disk which opens and closes the valve seat. The valve cover is mounted gastight on the opening by means of a bellows plate. A restoring spring between the valve disk and the valve cover is compressed on opening of the valve seat so that the valve closes under spring force. The valve cover has a port which feeds compressed air into and removes compressed air from a pressure chamber which is present on the bellows plate side and is bounded by the piston. The two ends of a bellows which surrounds the valve rod are fastened gastight to the inner edge surface of the bellows plate and to the valve disk. The valve disk has, on the surface facing the valve seat, an annular retaining groove in which a sealing ring is arranged.

The valve housing is as a rule made of aluminum or an elastomer or is coated internally with aluminum or another suitable material, while the valve disk and the bellows generally consist of steel. The bellows which is extendable and compressible along its longitudinal axis within the range of the adjustment distance of the disk seals the flow space airtight from the restoring spring, the valve rod and the pressure chamber. In particular, two types of bellows are used. Firstly, the membrane bellows and secondly the folding bellows, which latter is distinguished from the membrane bellows in that it has no weld seams and can be more easily cleaned but has a smaller maximum stroke.

Particularly susceptible to impurities in the flow space is the bellows, whose surface is relatively large owing to its wavy structure and forms a considerable surface for attack by the gas flowing through the flow space. Since the expandability of a bellows is limited and the bellows itself requires a relatively large amount of space axially even in the completely compressed state, the flow space of the valve must extend in a section which is opposite the valve seat and which is substantially larger than would be required for simple connection of the two ports. Otherwise, it is not possible completely to open the passage to the lateral port.

Furthermore, the valves known from the prior art have the disadvantage that the gas flowing through the valve in the flow space is exposed to different materials, in particular, on the one hand, the aluminum of the valve housing and, on the other hand, the steel of the bellows and of the disk. In the case of numerous gases, a reaction may occur between the gas and the material of the valve, so that it is desired to use as far as possible only a single material in the flow space of the valve. In some processes, the presence of steel is completely undesired. Thus, attempts have been made to provide a valve of the type mentioned at the outset, in whose flow space essentially exclusively aluminum or another material suitable for the respective process is used. In particular, however, aluminum is scarcely suitable for the production of a widely expandable bellows.

A further disadvantage is that the above-described structure of the valve mechanism results in a relatively extended construction of the valve.

### OBJECT OF THE INVENTION

It is therefore an object of the invention to solve the above-described problem of providing an only slightly soiling, easily cleanable, optionally completely openable valve of the type mentioned at the outset which can be formed with a process-neutral flow space, and thus to solve the conflict of aims which has not yet been sufficiently solved to date.

A further object of the invention is to make the valve as compact as possible by means of a reduced number of components.

### SUMMARY OF THE INVENTION

This object is achieved by realizing the characterizing features of the independent claims. Features which develop the invention in an alternative or advantageous manner are described in the dependent patent claims.

The valve according to the invention for essentially gastight closing of a flow path has a valve housing which has a first port in the direction of a first axis and a second port in the direction of the second axis essentially perpendicular to the first axis, so that the two ports are positioned at right angles and in the form of a corner relative to one another. The axes of the ports are defined by the longitudinal path thereof, the path of an arranged connecting piece or by the surfaces led into the flow space. The ports have, for example, a circular cross-section. The first port is enclosed by a valve seat which is arranged in the flow path of the flow space which connects the first port and the second port to one another. The flow space is that section of the valve which, in the closed or open state of the valve, can be flooded with gas at least from one of the two ports. Essentially opposite the valve seat is an opening in the valve housing, which however is closed gastight during normal operation of the valve.

The valve also has a cylindrical piston which is axially guided so as to be displaceable by an adjustment distance at least partly within the flow space along an axis perpendicular to the valve seat surface. This axis corresponds essentially to the first axis. However, it is alternatively possible for the axis to run in a slightly different direction. By displacing the piston, a piston closing surface facing the valve seat and having in particular a first seal member—for example in the form of an O-ring present in a fixing groove—can be brought into contact with the valve seat or out of contact therewith. As a result, the flow path is either closed essentially gastight or opened. The closing surface is formed by the end face of the piston. The closing surface and the valve seat surface are formed in such a way that they can come to rest one on top of the other. Preferably, the movement axis of the piston is perpendicular to the two surfaces. However, it is alternatively possible for the two surfaces to be formed so as to be oblique or uneven. In this case, the closing surface and the valve seat surface are to be understood as meaning virtual, averaged surfaces to which the axis is perpendicular.

A drive mechanism for displacing the piston is present in a position opposite the first port. At least one second seal member is arranged directly or indirectly between the piston and the valve housing in such a way that the flow space is separated essentially gastight from the opening and the drive mechanism.

The valve housing furthermore comprises, opposite the valve seat and adjacent to the flow space, a cylindrical passage which extends along the axis and through which the piston is passed and can be displaced. A sealing element or guide element is arranged inside the passage. The piston and the passage are dimensioned in such a way that the piston outer surface which is formed by the lateral surface of the piston is closely enclosed along the adjustment distance by the sealing or guide element of the passage. For example, at least one inner circumferential groove is formed in the passage, which groove holds a sealing ring as the sealing element in such a way that there is essentially gastight contact between the passage of the valve housing and the outer surface of the piston along the total axial adjustment distance of the piston. In this case, the sealing ring performs the function of the above-mentioned second seal member which is arranged between the piston and the valve housing in such a way that the flow space is separated essentially gastight from the opening and the drive mechanism.

An advantage of the valve according to the invention is that essentially only the valve housing and the piston are directly adjacent to the flow space of the valve. Since the gas flooding through the valve is therefore exposed only to the closing surface which can be made smooth, the piston outer surface which can be made smooth and the inner surface of the valve housing, the valve scarcely tends to become soiled and the reaction surface for the gas is small. The piston can be produced in particular from aluminum or another suitable material, so that it is possible to use only a single material in the flow space. Thus, the risk of undesired reactions between the valve component and the gas decreases. Furthermore, the proportion of the flow space volume directly involved in the flow-through is relatively large so that the flow losses are small.

The valve described is double-acting. In particular, the first port is connected to a vacuum chamber and the second port to a vacuum pump so that a relative reduced pressure prevails on the side of the first port after closing of the valve and switching off of the vacuum pump, by means of which reduced pressure the valve is kept closed. In this case, the drive mechanism need apply no force or a relatively small force for closing the valve and a relatively large force on the piston for opening the valve.

In a further development of the valve according to the invention, a piston step is formed on the piston, on the end which faces away from the valve seat and which points toward the opening. The piston step longitudinally adjacent to the piston section having the piston outer surface has, for example, a cylinder lateral surface coaxial with the piston outer surface. The external diameter of the piston step and the external diameter of the piston outer surface differ. The valve housing has a cylindrical piston chamber bounding the passage, extending along the axis and having a piston chamber inner surface. This piston chamber inner surface encloses the piston step closely and by means of a third seal member, in particular a sealing ring, essentially gastight, along the adjustment distance of the piston. As a result, an outer piston space linked to the adjustment distance is defined between the shoulders of the piston step and of the passage, which shoulders are opposite one another. By applying a relative excess pressure—or optionally a reduced pressure—in the outer piston space, the initially described displacement of the piston takes place. The excess pressure is preferably applied pneumatically via an opening in the valve housing. By means of this development, pressure is exerted directly and pneumatically on the piston. The drive mechanism mentioned at the outset is thus formed at least partly by the outer piston space, with the result that the piston performs not only the function of closing the valve slot but also a drive function. A substantial advantage of this further development is that the components involved in the drive mechanism are arranged radially relative to the piston so that the axial extension of the valve along the axis is small and the valve is formed so as to be compact and space-saving.

In one embodiment, the external diameter of the piston step is greater than the external diameter of the piston outer surface, with the result that the internal diameter of the piston chamber inner surface is greater than the internal diameter of the passage. In this case, the piston step projects beyond the piston outer surface and the section of the passage projects beyond the piston chamber inner surface. In this case, the valve is closed by applying a relative excess pressure in the outer piston space.

A converse development is alternatively possible, the external diameter of the piston being smaller than the external diameter of the piston outer surface. A disadvantage of this embodiment is that the passage and the piston step have to be formed relatively extended in the axial direction in order to permit a larger adjustment distance. By applying a relative excess pressure in the outer piston space, the valve is opened in this case.

### BRIEF DESCRIPTION OF THE DRAWINGS

The method according to the invention and the device according to the invention are described in more detail below, purely by way of example, with reference to specific embodiments shown schematically in the drawings. Specifically:

FIG. 1 shows a longitudinal section of an embodiment of a valve according to the invention in the completely opened state,

FIG. 2 shows the embodiment of the valve according to the invention in the completely closed state,

FIG. 3 shows a first further development of the embodiment of the valve according to the invention with an inner spring for closing the valve,

FIG. 4 shows a second further development of the embodiment of the valve according to the invention with an outer spring for opening the valve, and

FIG. 5 shows a third further development of the embodiment of the valve according to the invention with a bellows between the piston step and the passage.

### DESCRIPTION OF THE PREFERRED EMBODIMENTS

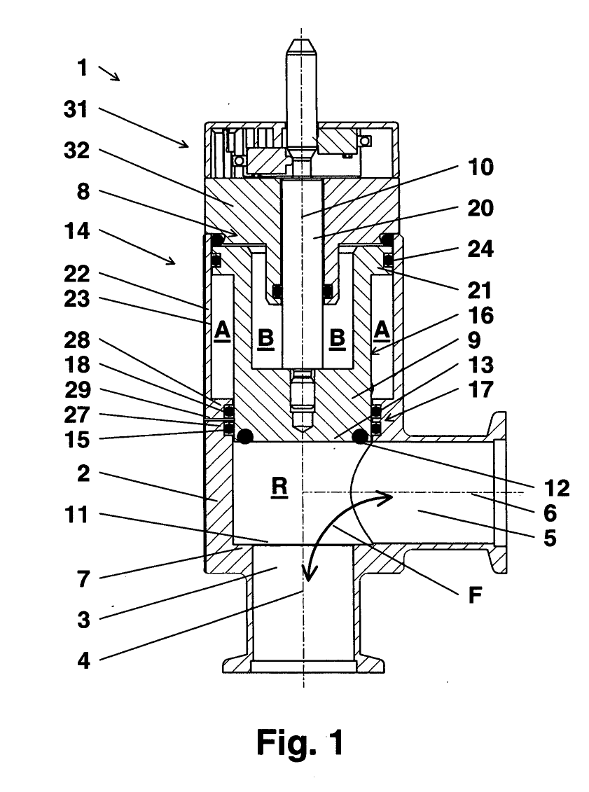

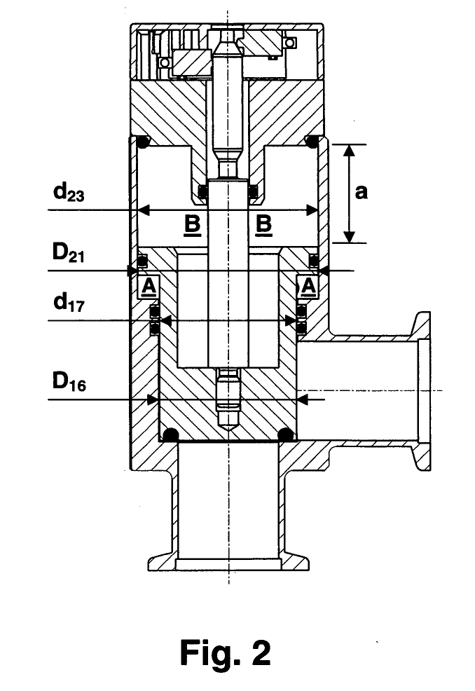

FIG. 1 shows an embodiment of a valve 1 according to the invention in a longitudinal section in the completely opened state. The same valve 1 is shown in FIG. 2, but in the completely closed state. For this reason, FIGS. 1 and 2 are described together below. Reference numerals already shown in FIG. 1 are dispensed with in FIG. 2.

The valve 1 has a valve housing 2 comprising a first port 3 and a second port 5. Both ports 3 and 5 each have a circular cross-section and are in the form of connecting pieces which lead into a flow space R of the valve 1. The ports 3 and 5 are arranged at right angles to one another—in the form of a corner—so that a first axis 4 of the first port 3 is perpendicular to a second axis 6 of the second port 5. The first axis 4 and the second axis 6 are defined by the longitudinal axis of the ports 3 and 5. A flow path F in the flow space R connects the first port 3 and the second port 5 to one another in the opened state of the valve 1. A valve seat 7 which surrounds the first port 3 in an annular manner, pointing toward the flow space R, and is arranged in the flow path F is formed in the valve housing 2. Opposite the valve seat 7, the valve housing 2 has an opening 8.

In addition, the valve 1 has a closable valve part in the form of a piston 9 which is displaceable at least partly inside the flow space R along an axis 10 perpendicular to a surface 11 of the valve seat 7. In the embodiment, the axis 10 is colinear with the first axis 4 of the first port 3. The piston is axially guided in particular by means of a valve rod 20 and is displaceable by an adjustment distance a in a manner such that a closing surface 13 of the valve parts 9, which faces the valve seat 7, can be brought into contact with the valve seat 7 for essentially gastight closing of the flow path F, as shown in FIG. 2, and can be brought out of contact for opening the flow path F, as shown in FIG. 1. The closing surface 13 is the end face of the piston 9. The lateral surface of the piston 9 forms a piston outer surface 16. A first seal member 12, which comes to rest on the valve seat 7 on closing the valve 1, is present on the closing surface 13. The valve housing 2 has a cylindrical passage 17 opposite the valve seat 7, adjacent to the flow space R, extending along the axis 10 and leading to a cylindrical piston chamber 22 extending along the axis 10. The piston 9 is passed through the passage 17 and is axially displaceable in it. Formed inside the passage 17 are a first inner circumferential groove 27 and, parallel to this, a second inner circumferential groove 28. For producing essentially gastight contact between the passage 17 and the piston outer surface 16, a first sealing ring 15 is fixed inside the first circumferential groove 27, and a second sealing ring 18 inside the second circumferential groove 28. Thus, the piston 9 is sealed gastight with respect to the passage 17, and the flow space R is separated gastight from the piston chamber 22. The piston 9 and the passage 17 are dimensioned so that the piston outer surface 16 is enclosed gastight along the adjustment distance a by the first sealing ring 15 and the second sealing ring 18 of the passage 17.

A cylindrical piston step 21 whose external diameter D₂₁ is greater than the external diameter D₁₆ of the piston outer surface 16 is formed on that side of the piston 9 which faces away from the valve seat 7 and points toward the opening 8.

The internal diameter d₂₃ of the piston chamber inner surface 23 is likewise greater than the internal diameter d₁₇ of the passage 17, the internal diameter d₂₃ being slightly greater than the external diameter D₂₁, and the internal diameter d₁₇ likewise being slightly greater than the external diameter D₁₆.

The cylindrical piston chamber 22 of the valve housing 2, which piston chamber extends along the axis 10 and bounds the passage 17, has a piston chamber inner surface 23 which encloses the piston step 21 closely and by means of a third seal member 24, essentially gastight, along the adjustment distance a of the piston 9. The third seal member 24 is, for example, in the form of a sealing ring and seals the piston 7 gastight with respect to the piston chamber inner surface 23 in the axial direction. An outer piston space A whose volume is linked to the adjustment distance a and is maximum when the valve is completely opened (cf. FIG. 1) and minimum when the valve is completely closed (cf. FIG. 2) is bounded by the facing shoulders of the piston step 21 and the passage 17. By applying a relative excess pressure in the outer piston space A, the piston 9 is pushed out of the flow space R and the valve 1 is opened. The converse behavior is observed when a relative reduced pressure is applied in the outer flow space R. Thus, the outer piston space A together with the piston 9 and the piston chamber 22 forms a drive mechanism 14 for displacing the piston 9.

The valve 1 can be used in particular for vacuum applications, so that a reduced pressure prevails in the flow space R. On the other hand, excess pressure prevails in the outer piston space A when the valve 1 is opened. In order to minimize the large pressure difference thus present at the first sealing ring 15 and at the second sealing ring 18 and in any case to prevent a transition from the excess pressure region to the reduced pressure region in the event of failure of a sealing ring 15 or 18, a vent hole 29 leading to neutral atmosphere is provided between the first and the second inner circumferential groove 27 and 28 for the atmospheric separation of the flow space R and of the outer piston space A in the valve housing 2.

An essentially gastight, inner piston space B which surrounds the valve rod 20 and whose volume is linked to the adjustment distance a and is maximum when valve 1 is completely closed and minimum when valve 1 is completely opened is formed on that side of the piston 9 which faces away from the valve seat 7 between a valve cover 32 closing the opening 8 and the piston 9. The application of a relative excess pressure or reduced pressure in the inner piston space B thus results in the displacement of the piston 9. The valve 1 is closed by excess pressure. Thus, the inner piston space B together with the piston 9, the piston chamber 22 and the valve cover 32 forms a drive mechanism 14 for displacing the piston 9.

The valve 1 described can be opened or closed pneumatically by applying an excess pressure either in the outer piston space A or in the inner piston space B.

A position sensor system 31 for electronic detection of the current position of the valve rod 20 and hence of the adjustment distance a is present on the valve cover 32, through which the valve rod 20 is passed.

The following further developments of the embodiment from FIGS. 1 and 2 have a very similar structure. For this reason, explanation of common components is substantially dispensed with.

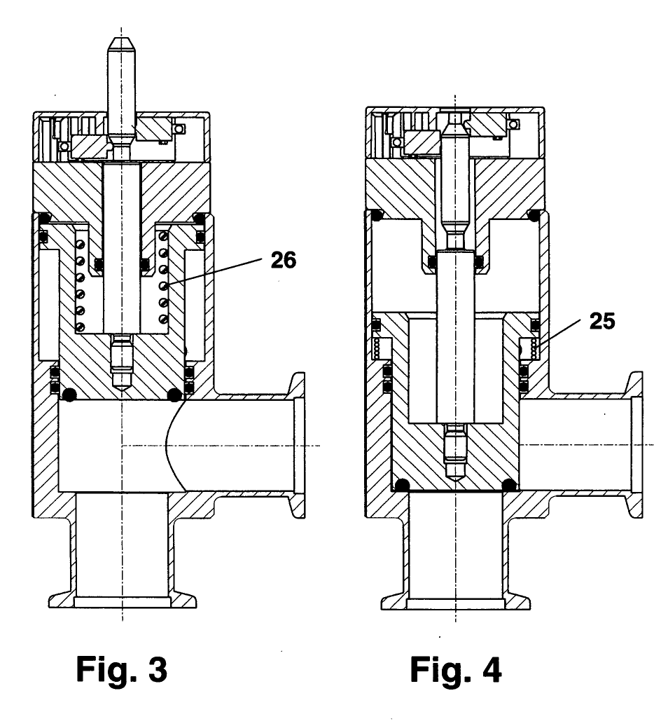

FIG. 3 shows a first further development of the embodiment. In the inner piston space B, an axially acting inner spring 26 for pressing the piston 9 under spring force in the direction of the valve seat 7 and hence for closing the flow path F is arranged axially between that side of the piston 9 which faces away from the flow space R, on the back of the closing surface 13, and the valve cover 32. In this embodiment, the valve 1 is thus self-closing if no pressure is present in the outer piston space A. If the spring force is sufficient for keeping the valve closed, the inner pressure space B can be completely dispensed with.

FIG. 4 shows a second further development of the embodiment. An axially extending and axially acting outer spring 25 for opening the valve under spring force and hence for opening the flow path F is arranged between the shoulders of the piston step 21 and the passage 17, which shoulders face one another, in the outer piston space A. In the case of this valve which opens through spring force, the outer piston space A can therefore be dispensed with. The valve is closed by applying an excess pressure in the inner piston space B.

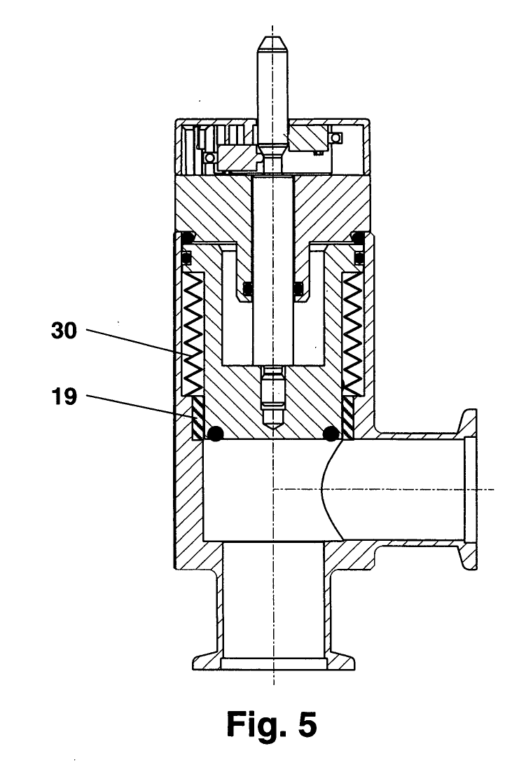

FIG. 5 shows a third further development of the embodiment of the valve according to the invention, comprising a bellows 30 extending along the axis 10, between the shoulders of the piston step 21 and the passage 17, which shoulders face one another, in the outer piston space A. Instead of the first and the second inner circumferential groove 27 and 28, and of the first and of the second sealing ring 15 and 18, an axial guide element 19, for example a bush, is arranged in the inside of the passage 17. The axial guide element 19 guides the piston 9, in a gas-permeable manner in the axial direction, along its piston outer surface 16 by the adjustment distance a. The bellows 30 which is flexible in the direction of the axis 10 is connected in a gastight manner to the piston step 21 and the passage 17 so that the bellows 30 is a seal member which is arranged between the piston 9 and the valve housing 2 in a manner such that the flow space R is separated essentially gastight from the outer piston space A surrounding the bellows 30 on the outside and capable of being subjected to pressure pneumatically for opening the valve.

1. A valve (1) for essentially gastight closing of a flow path (F) comprising
a valve housing (2) which has
a first port (3) in the direction of a first axis (4),
a second port (5) in the direction of a second axis (6) essentially perpendicular to the first axis (4),
a valve seat (7) which encloses the first port (3) and is arranged in the flow path (F) of a flow space (R) which connects the first port (3) and the second port (5) to one another, and
an opening (8) which is arranged essentially opposite the valve seat (7),
a valve part (9) which is axially guided and displaceable, at least partly inside the flow space (R), along an axis (10) corresponding essentially to the first axis (4), perpendicular to a surface (11) of the valve seat (7), by an adjustment distance (a), in a manner such that a closing surface (13) of the valve part (9) which faces the valve seat (7) and in particular has a first seal member (12) can be brought into contact with the valve seat (7) for essentially gastight closing of the flow path (F) and can be brought out of contact for opening of the flow path (F),
a drive mechanism (14) which is arranged in a position opposite the first port (3) for displacing the valve part (9), and
at least one second seal member (15, 30) which is arranged directly or indirectly between the valve part (9) and the valve housing (2) so that the flow space (R) is separated essentially gastight from the opening (8) and the drive mechanism (14),
wherein
the valve part is in the form of a cylindrical piston (9) comprising
an end face forming the closing surface (13) and
a lateral surface forming a piston outer surface (16) and
the valve housing (2) has, opposite the valve seat (7), a cylindrical passage (17) adjacent to the flow space (R) and extending along the axis (10),
through which the piston (9) is passed and can be displaced and
inside which a sealing or guide element (15, 18; 19) is arranged,
the piston (9) and the passage (17) being dimensioned so that the piston outer surface (16) is closely enclosed along the adjustment distance (a) by the sealing or guide element (15, 18; 19) of the passage (17).

2. The valve as claimed in claim 1, wherein
the piston (9) comprises a piston step (21),
which is formed on that side of the piston (9) which faces away from the valve seat (7) and
whose external diameter (D₂₁) differs from the external diameter (D₁₆) of the piston outer surface (16),
the valve housing (2) has a cylindrical piston chamber (22) bounding the passage (17), extending along the axis (10) and having a piston chamber inner surface (23), the piston chamber inner surface (23) enclosing the piston step (21) along the adjustment distance (a) of the piston (9), closely and by means of a third seal member (24), essentially gastight, so that
an outer piston space (A) linked to the adjustment distance (a) is bounded by the piston step (21) and the passage (17),
the piston (9) is displaced by applying a relative excess pressure or reduced pressure in the outer piston space (A) and
the drive mechanism (14) is formed at least partly by the outer piston space (A).

3. The valve as claimed in claim 2, wherein the external diameter (D₂₁) of the piston step (21) is greater than the external diameter (D₁₆) of the piston outer surface (16) and hence the internal diameter (d₂₃) of the piston chamber inner surface (23) is greater than the internal diameter (d₁₇) of the passage (17).

4. The valve as claimed in claim 3, wherein
an essentially gastight, inner piston space (B) linked to the adjustment distance (a) is formed on that side of the piston (9) which faces away from the valve seat (7), between a valve cover (32) closing the opening (8) and the piston (9),
the piston (9) is displaced by applying a relative excess pressure or reduced pressure in the inner piston space (B) and
the drive mechanism (14) is formed at least partly by the inner piston space (B).

5. The valve as claimed in claim 3, wherein an axially acting outer spring (25) for opening the flow path (F) under spring force is arranged in the outer piston space (A), axially between the piston step (21) and the passage (17).

6. The valve as claimed in claim 4, wherein an axially acting inner spring (26) for closing the flow path (F) under spring force is arranged in the inner piston space (B), axially between the piston (9) and the valve cover (32).

7. The valve as claimed in claim 1, wherein
the passage (17) has a first inner circumferential groove (27),
the sealing or guide element forms the second seal member and is in the form of a first sealing ring (15), and
the first sealing ring (15) is arranged inside the first circumferential groove (27) for producing an essentially gastight contact between the passage (17) and the piston outer surface (16).

8. The valve as claimed in claim 7, wherein
the passage (17) has a second inner circumferential groove (28) parallel to the first inner circumferential groove (27),
a second sealing ring (18) is arranged inside the second circumferential groove (28) for producing further essentially gastight contact between the passage (17 and the piston outer surface (16), and
a vent hole (29) leading to neutral atmosphere is provided between the first and the second inner circumferential groove (27, 28) for atmospheric separation of the flow space (R) and of the outer piston space (A) in the valve housing (2).

9. The valve as claimed in claim 3, wherein
a bellows (30) extending along the axis (10) is arranged in the outer piston space (A), axially between the piston step (21) and the passage (17),
the bellows (30) forms the second seal member and
the sealing or guide element is in the form of an axial guide element (19) which guides the piston outer surface (16) axially along the adjustment distance (a) in a gas-permeable manner.
